(19) United States
(12) Patent Application Publication
(10) Pub. No.: US 2006/0260477 A1
(43) Pub. Date: Nov. 23, 2006

(54) Food processing

(76) Inventors: Nicholas Jackman, Limerick (IE); Steven Higgins, Portlaois (IE)

Correspondence Address: BIRCH STEWART KOLASCH & BIRCH, PO BOX 747, FALLS CHURCH, VA, 22040-0747, US

(21) Appl. No.: 10/546,481

(22) PCT Filed: Feb. 24, 2004
(86) PCT No.: PCT/IE04/00026

§ 371 Date: Jul. 5, 2006

(30) Foreign Application Priority Data
Feb. 24, 2003 (IE) S2003/0130

(51) Int. Cl. A23G 1/10

(52) U.S. Cl. 99/485

(57) ABSTRACT

Apparatus (40) for the thermal treatment of food products includes a food processing conveyor (46) which is operable to deliver food products between an inlet (44) and an 10 outlet (45) of the apparatus (40) for cooking at a cooking station (42) followed by delivery through a marking station (43) for branding a surface of the product with a desired surface marking or design.

### BACKGROUND OF THE INVENTION

This invention relates to food processing, to apparatus and a process for the thermal treatment of food products and in particular to the cooking and/or surface treatment of food products.

Various types of apparatus are available for the thermal treatment of food products by for example cooking or chilling the food products. Examples are to be found in Irish Patent No. 74240 and PCT Patent Specification No. WO 93/19334.

It is an object of the present invention to provide an improved food processing system and apparatus in particular for high speed cooking of products in a production line.

### SUMMARY OF THE INVENTION

According to the invention there is provided apparatus for the thermal treatment of food products, including:
a food processing conveyor,
a cooking station,
a marking station,
said food processing conveyor being operable to deriver a food product to the cooking station and then to the marking station which is located downstream of the cooking station,
the cooking station having means for directing a heated gas stream at relatively high velocity at a product on said conveyor,
the marking station having means for engaging and branding a surface of a product with a desired surface marking or design.

In a preferred embodiment the cooking station has means for generating the high velocity gas stream. Said means preferably includes means for mixing air and steam to provide the gas stream.

In one embodiment the marking station includes a branding device for branding a surface of a food product with markings simulating spaced-apart bars or a grill effect.

In another embodiment the marking station includes a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product.

In a particularly preferred embodiment of the invention the branding element is mounted across a product delivery path for delivery of product past the branding element between said path and said branding element, and each of said discs is independently movable on the support towards and away from said path. Thus advantageously the branding device can accommodate uneven products such as pieces of meat or fish for example. The branding device of the invention facilitates the surface marking of food products to get a bar or grill effect on the surface of the food product.

In another embodiment means is provided for adjustment of the spacing between the branding element and the product delivery path. This facilitates the handling of products of various thicknesses.

In another embodiment each branding disc is rotatable.

Preferably drive means is provided for rotating the support on which the branding-discs are mounted.

In another embodiment the speed at which the drive means rotates the support is directly proportional to the speed at which a product is delivered along the product delivery path.

In a preferred embodiment each branding disc is annular having a central through hole for through passage of a shaft of the support, said shaft having an outside diameter which is sized smaller than the inside diameter of the through hole in the disc to allow movement of the disc relative to the shaft This advantageously allows movement of the disc to accommodate products of different sees and having an uneven profile.

In another embodiment spacing means is provided for maintaining the discs spaced-apart on the support.

In a preferred embodiment the spacing means comprises a spacer flange projecting outwardly from one side face of each disc for engagement with the opposite side face of the next adjacent disc on the support.

In another embodiment the heating means comprises a heater having a gas burner mounted adjacent the branding element and operable to direct flame generated by the burner towards discs for heating the discs.

Conveniently the heating means may be movable between a first position for heating the branding discs and a second position for directing heat towards the product delivery path for searing a top of products delivered along the product delivery path.

In another aspect the invention provides apparatus for the thermal treatment of food products, including:
an oven,
the oven having an inlet and an outlet,
means for conveying a food product along a product delivery path between the inlet and the outlet,
a cooking apparatus mounted within the oven for cooking a product delivered along the product delivery path, and
a branding device downstream of the cooking apparatus for branding an exterior surface of a product delivered along the product delivery path.

While any suitable cooking apparatus could be provided it is preferred that the cooking apparatus be of the type having means for directing a collimated air stream at relatively high velocity towards the product delivery path for cooking products delivered along said product delivery path. Preferably also means is provided for incorporating steam in said air stream.

In another aspect the invention provides apparatus for the thermal treatment of food products, including:
an oven,
the oven having an inlet and an outlet,
means for conveying a food product along a product delivery path between the inlet and the outlet,
a cooking apparatus mounted within the oven for cooking a product delivered along the product delivery path, and
a searing device downstream of the cooking apparatus for searing an exterior surface of a product delivered along the product delivery path.

In another aspect the invention provides a branding device of the type described herein.

In a further aspect the invention provides a method for the thermal treatment of a food product, including:
delivering the product to a cooking station,
at least partially cooking the product at the cooking station by directing a heated gas stream at relatively high velocity at the product,
delivering the product to a marking station downstream of the cooking station, and
at said marking station engaging a surface of the product with branding means for applying a preselected desired surface marking or design to an outer surface of the product.

Preferably the method includes forming the gas stream by mixing air and steam before directing the gas stream at the product.

### BRIEF DESCRIPTION OF THE DRAWINGS

The invention will be more clearly understood by the following description of some embodiments thereof, given by way of example only, with reference to the accompanying drawings, in which;

FIG. 1 is an elevational view of a branding device according to the invention;

FIG. 2 is an end elevation view of the branding device;

FIG. 3 is a plan view of the branding device;

FIG. 4 is a perspective view of a branding disc forming portion of the branding device;

FIG. 5 is an elevational view of the branding disc shown in FIG. 4;

FIG. 6 is an end elevational view of the branding disc shown in FIG. 4;

FIG. 7 is a sectional end elevational view of the branding disc shown in FIG. 4;

FIG. 8 is a sectional elevational view of apparatus for the thermal treatment of food products according to another aspect of the invention;

FIG. 9 is a sectional plan view of the apparatus shown in FIG. 8;

FIG. 10 is a sectional end elevational view showing one end of the apparatus of FIG. 8;

FIG. 11 is a sectional end elevational view showing another end of the apparatus shown in FIG. 8;

FIG. 12 is a plan view of the apparatus shown in FIG. 8;

FIG. 13 is an elevational view of the apparatus shown in FIG. 8;

FIG. 14 is an end elevational view of the apparatus shown in FIG. 8, showing an inlet end of the apparatus; and

FIG. 15 is an end elevational view of the apparatus shown in FIG. 8, showing an outlet end of the apparatus.

### DETAILED DESCRIPTION OF PREFERRED EMBODIMENTS

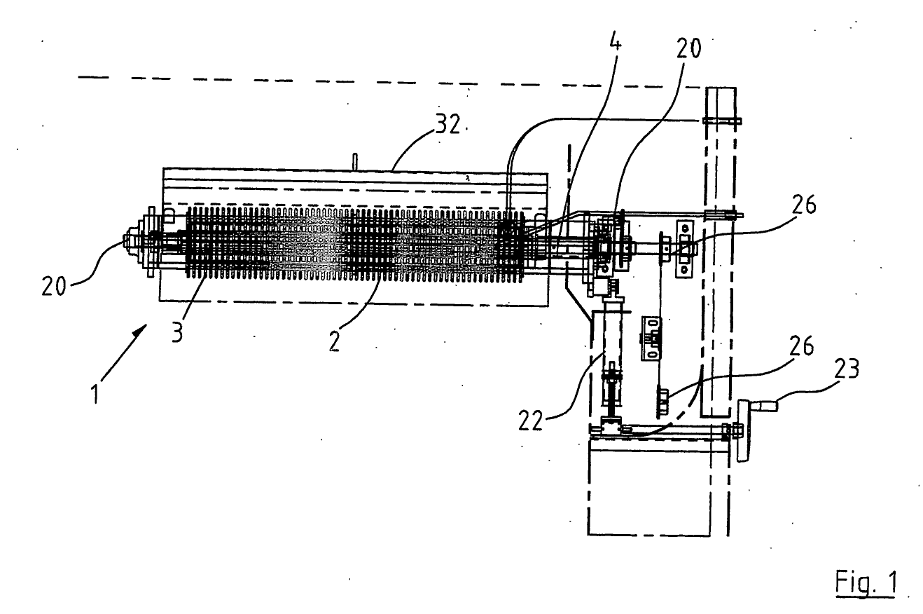

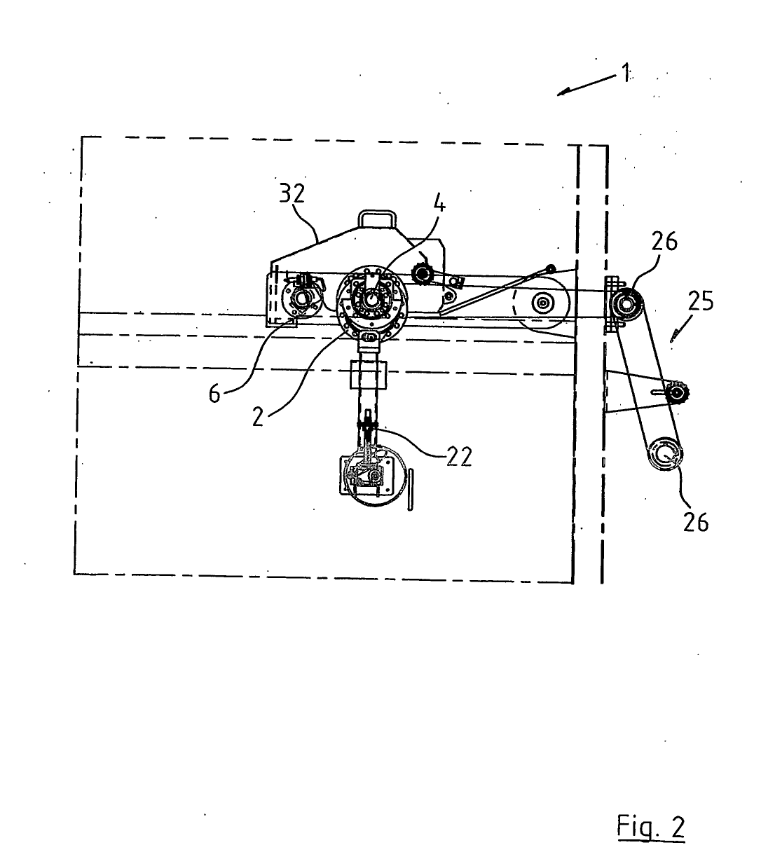

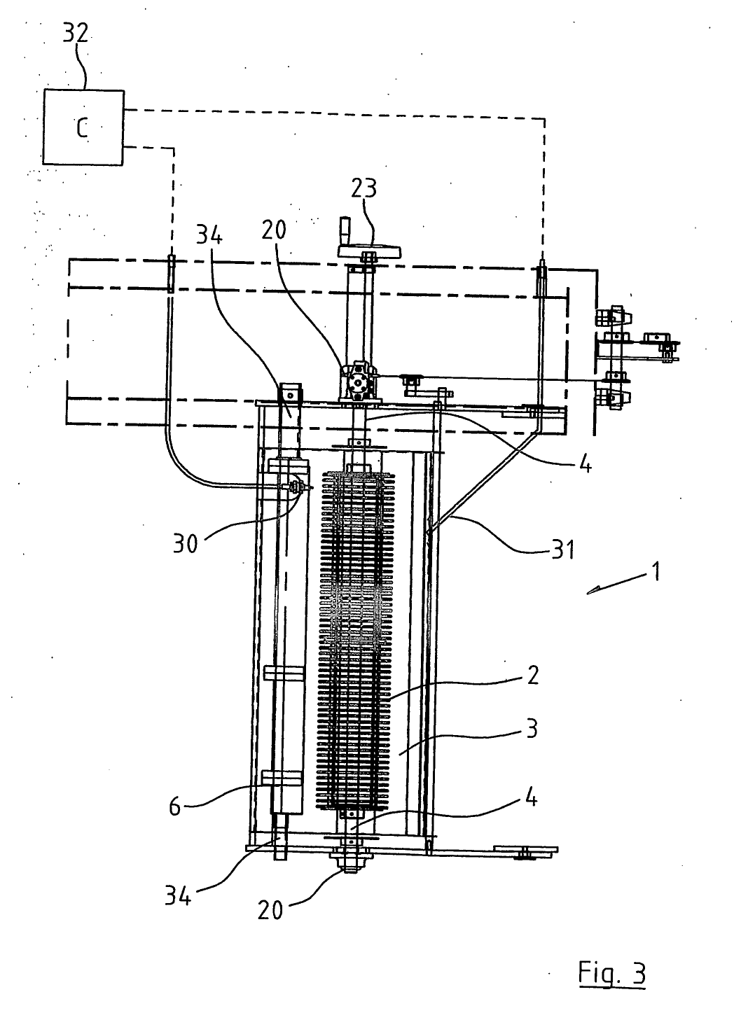

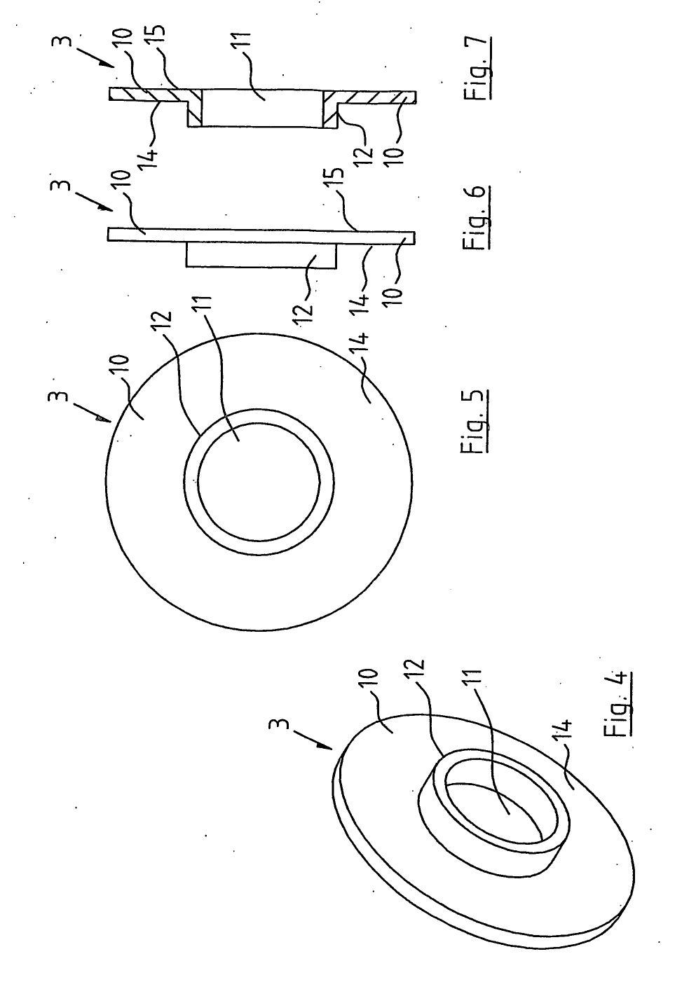

Referring to the drawings, and initially to FIGS. 1 to 7 thereof, there is illustrated a branding device according to the invention indicated generally by the reference numeral 1. The branding device 1 includes a branding element 2 comprising a number of spaced-apart branding discs 3 mounted on a support shaft 4. A ribbon burner 6 is mounted adjacent the branding element 2 and is operable to direct flame generated by the burner 6 towards the discs 3 for heating a periphery of each of said braiding discs 3. The heated discs 3 are engagable with a food product delivered on a conveyor beneath the branding element 2 to brand the top surface of the food product with a bar or grill effect.

Referring in particular to FIGS. 4 to 7, each branding disc 3 has an annular body 10 with a central through hole 11 for through passage of the shaft 4 on which the discs 3 are mounted. It will be noted that an inside diameter of the hole 11 is of greater size than the outside diameter of the shaft 4 and this allows a limited radial movement of the disc 3 relative to the shaft 4 when the disc 3 is mounted on the shaft 4. A circular spacer flange 12 projects outwardly from one side face 14 of each disc 3 for engagement with the opposite flat side face 15 of the next adjacent disc 3 on the shaft 14. Thus adjacent discs 3 on the shaft 4 are able to slide vertically relative to each other on the shaft 4 to accommodate the profile of a food product passing beneath the branding element 2.

About sixty discs 3 are mounted side by side on the shaft 4. The shaft 4 is supported horizontally between high temperature bearings 20 mounted on a support frame. Some vertical adjustment of the shaft 4 on the support frame is possible by means of a jack 22 operated by a hand wheel 23 to raise and lower the shaft 4 and thus alter the distance between a lowermost branding edge of the discs 3 and the product delivery path or conveyor which passes beneath the branding element 2 to accommodate food products of different size.

The shaft 4 carrying the discs 3 is rotatable. A chain drive 25 acting through sprockets 26 connects the shaft 4 to the drive for a conveyor for delivery of the food products beneath the branding element 2 as will be described later. The drive is such that a bottom of each disc 3 which contacts a food product on the conveyor is traveling in the same direction as the conveyor and thus each disc 3 effectively rolls over the top of the food product as it passes beneath the disc 3.

The burner 6 is a ribbon burner and is connected to a gas supply (not shown). An ignitor 30 is provided for staring the burner 6 and is connected up to a controller (32) for the burner 6. Also connected to the controller 32 is a temperature probe 31 for control of the heat generated by the burner 6.

A cover 32 is mounted over the burner 6 and branding element 2 to concentrate heat at the branding element 2. It will be noted that the burner 6 is mounted on a pivot support 34. In this way the burner 6 can be pivoted between a first position in which the burner flame is directed at the discs 3 and a second position in which the burner flame is directed downwardly towards a conveyor which carries the food products beneath the branding element 2 in order to sear a top surface of food products as they pass beneath the burner 6. This provides the facility for surface browning or for example melting cheeses on the top surface of a food product as it is delivered beneath the burner 6.

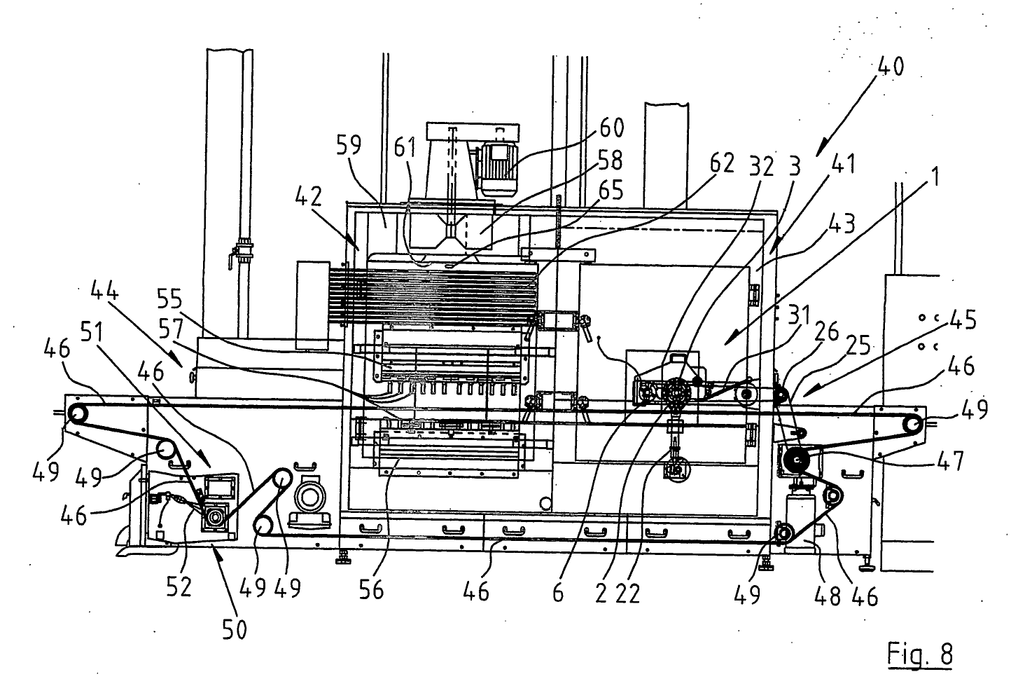

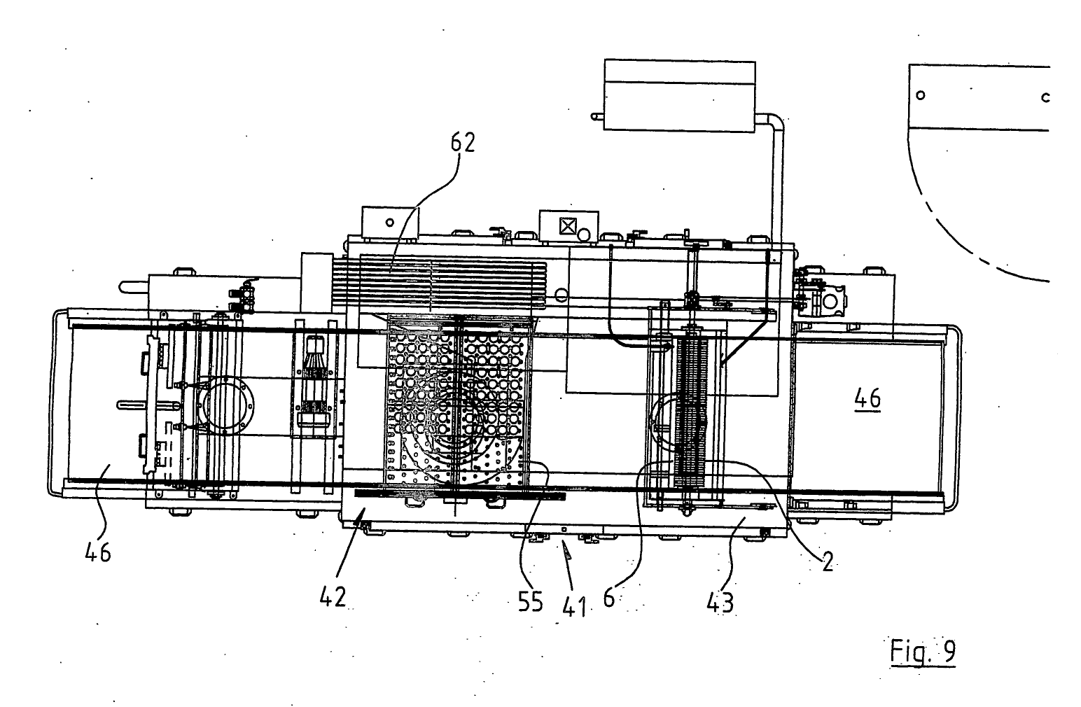

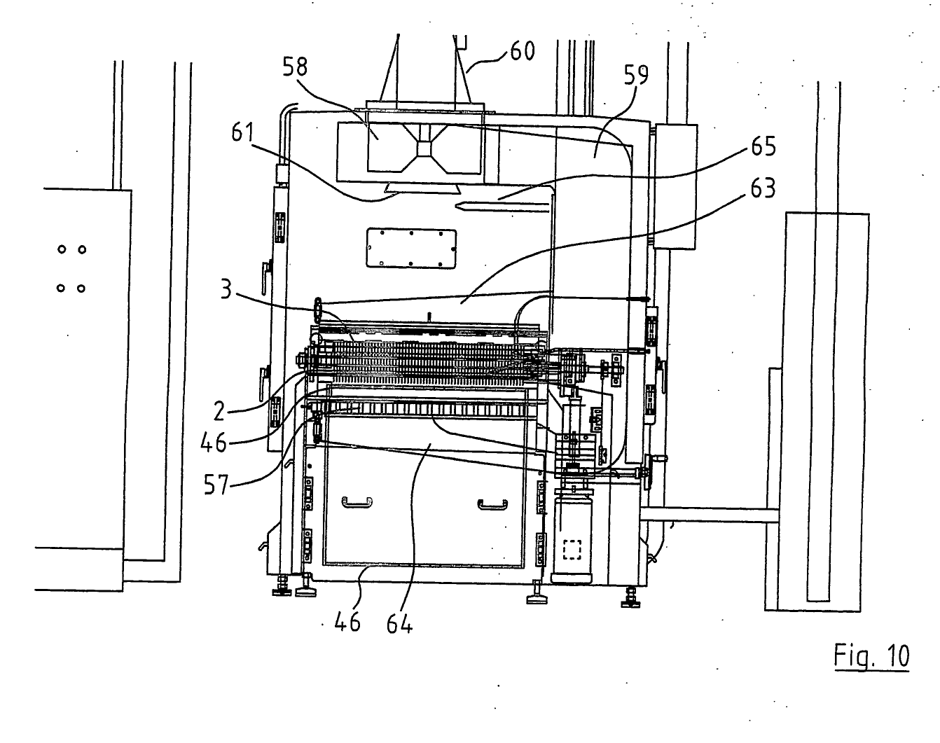

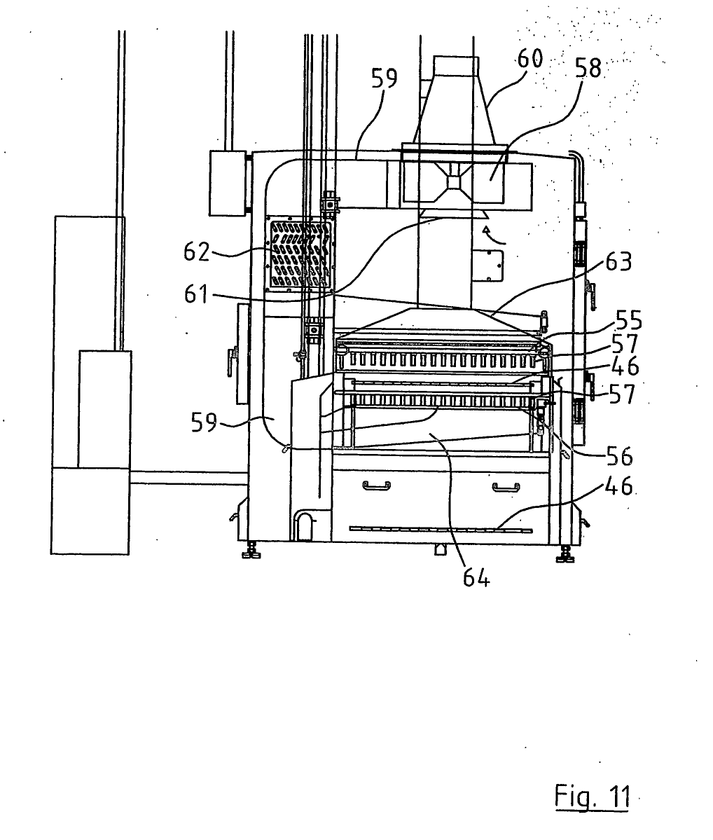

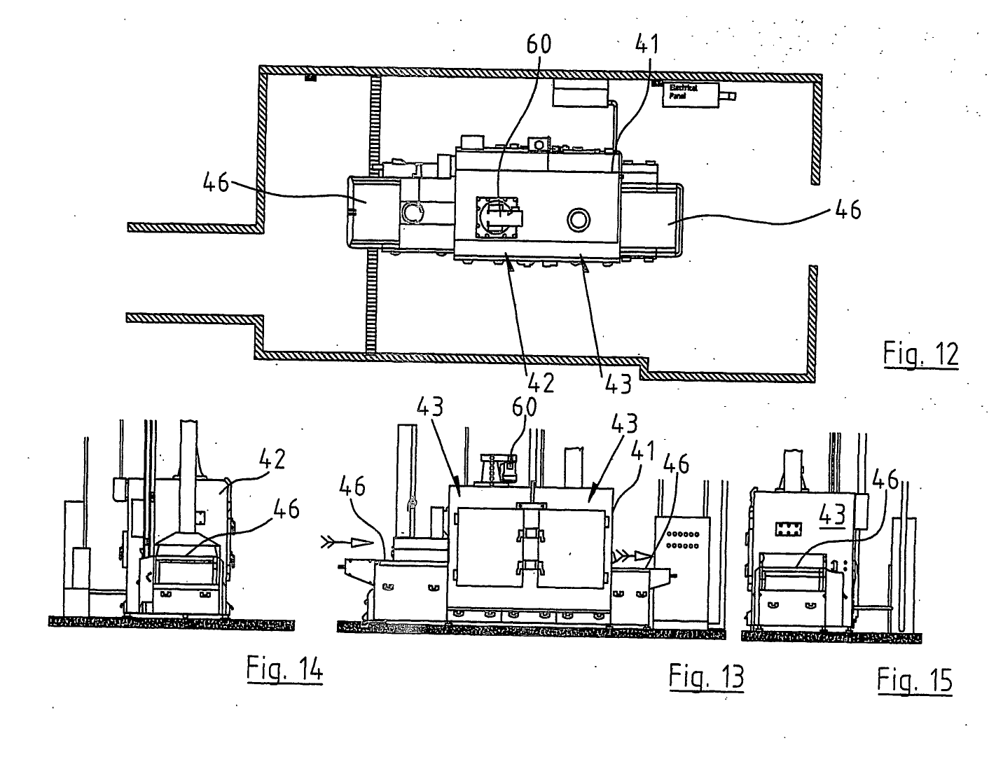

Referring now to FIGS. 8 to 15 there is shown apparatus for the thermal treatment of food products according to a second aspect of the invention, the apparatus being indicated generally by the reference numeral 40. This apparatus 40 incorporates the burner device 1 described previously with reference to FIGS. 1 to 7. The apparatus 40 has an oven 41 with a cooking station 42 and a marking station 43 downstream of the cooking station 42. The oven 40 has an inlet 44 and an outlet 45. An endless metal mesh conveyor belt 46 is operable to deliver food products between the inlet 44 and the outlet 45 for cooking and/or otherwise treating by branding or searing food products delivered along the conveyor 46. A drive roller 47 driveably connected to a drive motor 48 drives the conveyor belt 46 around various support rollers 49 only some of which are shown. Means is provided for varying the speed of the drive and thus the speed of the conveyor belt 46. The drive to the roller 47 is also connected to the chain drive mechanism 25 for rotation of the branding element 2. Thus the speed of rotation of the branding element 2 is directly proportional to the conveyor belt 46 speed and they speed up and slow down together.

A belt cleaner 50 is provided adjacent the inlet 44 of the oven 41. This comprises a housing 51 through which the conveyor belt 46 is delivered. A high pressure water spray 52 is directed at the belt 46 within the housing 51 to clean the conveyor belt 46.

Within the cooking station 42 of the oven 41 the conveyor belt 46 passes between a pair of nozzle banks, namely an upper nozzle bank 55 located above the conveyor belt 46 and an associated lower nozzle bank 56, located beneath the conveyor belt 46. Each nozzle bank 55, 56 has a plurality of spaced apart nozzles 57 for directing a collimated air stream at relatively high velocity towards the conveyor belt 46 for cooking products delivered along the conveyor belt 46 between the nozzle banks 55, 56.

The velocity of the air stream will typically be in the range 10 n/s to 30 m/s. Which speed is used will depend on the product being cooked. For more delicate products the air speed will be towards the lower end of the range.

The lower nozzle bank 56 is fixed. The upper nozzle bank 55 may also be fixed. Alternatively, the upper nozzle bank 55 may be adjustable, allowing vertical movement towards and away from the conveyor belt 46 for adjustment of the spacing between the nozzle 57 outlets and the conveyor belt 46. This spacing would typically be adjustable in the range 50 mm to 250 mm. The adjustability, where provided, conveniently allows further control of the cooking of different types of product. Any suitable mechanism for raising and lowering the upper nozzle bank 55 may be provided.

Air is delivered to the nozzle banks 55, 56 by means of a fan 58 located within an air trunking 59 and driven by a motor 60. The fan 58 has a central inlet 61 and discharges air through the trunking 59, through a heater 62 into air manifolds 63, 64 feeding the nozzle banks 55, 56 respectively. Air discharged through the nozzles 57 is re-circulated through the fan 58.

A steam nozzle 65 is provided at the inlet 61 of the fan 58 and is operable if required for full mixing of steam and air at the inlet 61 prior to delivery of the combined steam and air mixture through the nozzles 57.

The temperature of the air or the combined steam and air mixture will typically be in the range 100° C. to 320° C. This is adjustable to accommodate a range of product cooking requirements by control of the stream and/or heater 62.

In use, a food product such as for example a burger is placed on the conveyor belt 46 at the inlet end 44 of the oven 41 and it is delivered firstly into the cooking station 42 where it passes between the banks 55, 56 of nozzles 57. A mixture of air and steam is delivered by the fan 58 through the trunking 59 to the nozzles 57 where it is discharged at relatively high velocity for partially cooking the burger. The hot air/steam mixture impinges against the burger at high velocity, quickly setting the protein in an outer layer of the food product, killing the bacteria in said outer layer. Downstream of the cooking station 42 a partially cooked burger is delivered by the conveyor belt 46 beneath the branding element 2. The burner 6 heats the periphery of the discs 3. As the burger passes beneath the discs 3 the top surface of the burger is marked by a number of juxtaposed discs 3 beneath which the burger passes, said discs 3 rolling over the top surface of the burger to provide a grill bar effect of spaced-apart grill lines on the surface of the burger. When the burger is discharged from the oven 41 it can be delivered for packaging in any suitable fashion.

It will be noted that a pair of spaced-apart branding elements 2 may be provided for branding both sides of the food product, with the food product passing between the branding elements 2 which engage and mark opposite sides of the food product Alternatively a pair of branding elements 2 in series may be provided with the product passing through these first and second branding elements in turn with means to flip over the product between said first and second branding elements 2 to mark both sides of the product in turn with an overhead branding element 2.

In some cases, instead of branding it is desirable to sear a top surface of a product such as lasagne for example. In this case, if the burner 6 is rotated into the downwardly facing position and as the food product such as lasagne is delivered beneath the burner 6 the top surface is seared.

It will be appreciated that the invention allows high speed steam searing or cooking and marking of a product. These two processing steps in accordance with the invention can be carried out in-line in a relatively short time, typically in the order of twenty seconds as opposed to the several minutes usually taken for similar operations using conventional apparatus and methods. The high speed steam searing using high impingement velocity steam quickly sets the protein in an outer layer of the food product, killing the bacteria in said outer layer. The marking downstream of the steam searing gives a desirable surface appearance to the product.

It will further be appreciated that the apparatus of the invention is extremely versatile and allows partial or full cooking (with or without steam) with either searing or branding, or simply cooking (with or without steam) or searing or branding of products as they are delivered through the oven 41 on the conveyor belt 46.

The apparatus can be used for fully or partially cooking various products, including meat products such as chicken, beef, pork and fish products and various other food products such as vegetables or pasta for example. Searing may be carried out on various products such as vegetable products, fish products, pasta products for example.

The invention is not limited to the embodiments hereinbefore described which may be varied in both construction and detail within the scope of the appended claims.

1. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design.

2. Apparatus as claimed in claim 1 wherein the marking station includes a branding device for branding a surface of a food product with markings to simulate a desired cooking effect.

3. Apparatus as claimed in any preceding claim wherein including means for mixing air and steam to provide the gas stream.

4. Apparatus as claimed in any preceding claim wherein the marking station includes a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product

5. Apparatus as claimed in claim 4 wherein, the branding element is mounted across a product delivery path defined by the food processing conveyor for delivery of a product past the branding element between said path and said branding element, and each of said discs is independently movable on the support towards and away from said path.

6. Apparatus as claimed in claim 5 wherein means is provided for adjustment of the spacing between the branding element and the product delivery path.

7. Apparatus as claimed in claim 6 wherein the branding disc support is movable by means of a jack relative to the product delivery path.

8. Apparatus as claimed in any of claims 4 to 7 wherein each branding disc is rotatable.

9. Apparatus as claimed in any of claims 4 to 8 wherein drive means is provided for rotating the support on which the branding discs are mounted.

10. Apparatus as claimed in claim 9 wherein the speed at which the drive means rotates the support is directly proportional to the speed at which a product is delivered along the product delivery path.

11. Apparatus as claimed in claim 9 or 10 wherein the branding disc drive means and a food processing conveyor drive means are interconnected.

12. Apparatus as claimed in any of claims 4 to 11 wherein each branding disc is annular having a central through hole for through passage of a shaft of the support, said shaft having an outside diameter which is sized smaller than the inside diameter of the through hole in the disc to allow radial movement of the disc relative to the shaft.

13. Apparatus as claimed in any of claims 4 to 12 wherein spacing means is provided for maintaining the discs spaced-apart on the support.

14. Appartus as claimed in claim 13 wherein the spacing means comprises a spacer flange projecting outwardly from one side face of each disc for engagement with the opposite side face of the next adjacent disc on the support, said adjacent discs being slidable relative to each other.

15. Apparatus as claimed in any of claims 4 to 14 wherein the heating means comprises a heater having a gas burner mounted adjacent the branding element and operable to direct flame generated by the burner towards discs for heating the discs.

16. Apparatus as claimed in claim 15 wherein the heating means is movable between a first position for heating the branding discs and a second position for directing heat towards the product delivery path for searing a top of products delivered along the product delivery path.

17. Apparatus for the thermal treatment of food products, including:
an oven,
the oven having an inlet and an outlet,
means for conveying a food product along a product delivery path between the inlet and the outlet,
a cooking apparatus mounted within the oven for cooking a product delivered along the product delivery path, and
a branding device downstream of the cooling apparatus for branding an exterior surface of a product delivered along the product delivery path.

18. Apparatus as claimed in claim 17 wherein the cooking apparatus is of the type having means for directing a collimated air stream at relatively high velocity towards the product delivery path for cooking products delivered along said product delivery path.

19. Apparatus as claimed in claim 18 wherein means is provided for incorporating steam in said air stream.

20. Apparatus for the thermal treatment of food products, including:
an oven,
the oven having an inlet and an outlet,
means for conveying a food product along a product delivery path between the inlet and the outlet,
a cooking apparatus mounted within the oven for cooking a product delivered along the product delivery path, and
a searing device downstream of the cooking apparatus for searing an exterior surface of a product delivered along the product delivery path.

21. A method for the thermal treatment of a food product, including:
delivering the product to a cooking station,
at least partially cooking the product at the cooking station by directing a heated gas stream at relatively high velocity at the product,
delivering the product to a marking station downstream of the cooking station, and
at said marking station engaging a surface of the product with branding means for applying a preselected desired surface marking or design to an outer surface of the product.

22. A method as claimed in claim 21 wherein the method includes forming the gas stream by mixing air and steam before directing the gas stream at the product

23. Apparatus for the thermal treatment of food products, including:
a food processing conveyor,
a cooling station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design,
said marking station including a branding device for branding a surface of a food product with markings to simulate a desired cooking effect.

24. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design,
said marking station including a branding device for branding a surface of a food product with markings to simulate a desired cooking effect,
the marking station including a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product.

25. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design,
said marking station including a branding device for branding a surface of a food product with markings to simulate a desired cooking effect,
the marking station including a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product,
the branding element being mounted across a product delivery path defined by the food processing conveyor for delivery of a product past the branding element between said path and said branding element, and each of said discs being independently movable on the support towards and away from said path.

26. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design;
said marking station including a branding device for branding a surface of a food product with markings to simulate a desired cooking effect,
the marking station including a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product,
the branding element being mounted across a product delivery path defined by the food processing conveyor for delivery of a product past the branding element between said path and said branding element, and each of said discs being independently movable on the support towards and away from said path,
each branding disc-being rotatable,
drive means being provided for rotating the support on which the branding discs are mounted.

27. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design,
said marking station including a branding device for branding a surface of a food product with markings to simulate a desired cooking effect,
the marking station including a branding device having a branding element comprising a number of spaced-apart branding discs mounted on a support, means for heating a periphery of each of said branding discs to a desired branding temperature, and means for delivering a product into engagement with a periphery of at least some of said discs for branding an exterior surface of the product,
the branding element being mounted across a product delivery path defined by the food processing conveyor for delivery of a product past the branding element between said path and said branding element, and each of said discs being independently movable on the support towards and away from said path,
each branding disc being rotatable,
drive means being provided for rotating the support on which the branding discs are mounted,
the speed at which the drive means rotates the support being directly proportional to the speed at which a product is delivered along the product delivery path.

28. Apparatus for the thermal treatment of food products, including:
a food processing conveyor,
a cooking station,
a marking station,
said food processing conveyor being operable to deliver a food product to the cooking station and then to the marking station which is located downstream of the cooking station,
the cooking station having means for generating and directing a heated gas stream at relatively high velocity at a product on said conveyor,
the marking station having means for engaging and branding a surface of a product with a desired surface marking or design,
said marking station including a branding device for branding a surface of a food product with markings to simulate a desired cooking effect,
the marking station including a branding device having a branding element comprising a number of spaced apart branding discs mounted on a support, means for heating a periphery of each of said branding discs to a desired branding temperature, and means for delivering a product into engagement with a periphery of at least some of said discs for branding an exterior surface of the product,
the branding element being mounted across a product delivery path defined by the food processing conveyor for delivery of a product past the branding element between said path and said branding element, and each of said discs being independently movable on the support towards and away from said path,
each branding disc being rotatable,
drive means being provided for rotating the support on which the branding discs are mounted,
the speed at which the drive means rotates the support being directly proportional to the speed at which a product is delivered along the product delivery path,
the heating means comprising a heater having a gas burner mounted adjacent the branding element and operable to direct flame generated by the burner towards discs for heating the discs,
the heating means being movable between a first position for heating the branding discs and a second position for directing heat towards the product delivery path for searing a top of products delivered along the product delivery path.
